(19) United States
(12) Patent Application Publication
(10) Pub. No.: US 2004/0125132 A1
(43) Pub. Date: Jul. 1, 2004

(54) Method, apparatus and program for supplying content-related information

(76) Inventors: Jin Katagiri, Kanagawa-ken (JP); Taro Yokoyama, Tokyo (JP)

Correspondence Address: HARNESS, DICKEY & PIERCE, P.L.C., P.O. BOX 828, BLOOMFIELD HILLS, MI, 48303, US

(21) Appl. No.: 10/727,866

(22) Filed: Dec. 4, 2003

(30) Foreign Application Priority Data
Dec. 10, 2002 (JP) 2002-357683

(51) Int. Cl. G09G 5/00; G06F 15/16

(52) U.S. Cl. 345/739; 709/203; 709/219

(57) ABSTRACT

User is caused to select, from among a plurality of pieces of data reproducing equipment, particular data reproducing equipment to be used, and the selected particular data reproducing equipment is registered in association with the user. A plurality of items of content is searched for particular content reproducible with the data reproducing equipment registered in association with the user. Content displaying information indicative of the searched-out content is supplied to the user. Thus, with reference to the supplied content displaying information, the user can determine whether or not to acquire (purchase or test-use) necessary content.

### BACKGROUND OF THE INVENTION

The present invention relates generally to content-delivering information supplying methods, programs or apparatus for supplying users with content displaying information suitable for reference by the users when designating content deliverable via wireless or wired communication networks, such as the Internet. More particularly, the present invention relates to an improved content-delivering information supplying method, apparatus and program which, for each of data reproducing equipment possessed by individual users, can supply the user with only content displaying information indicative of content usable in the data reproducing equipment.

With the recent rapid development of wireless or wired communication networks, typified by the Internet, every interested person can use desired content in any place and at any desired time by using a personal computer, portable telephone (e.g., cellular phone) or the like to access a desired WWW (World Wide Web) site on a communication network and download the user desired content from the WWW site on a free-of-charge or chargeable basis. For example, the user can access a predetermined music data selling site, having prestored therein a multiplicity of music piece data sets of, for example, the MIDI standard to be used for reproducing music pieces and musical score data sets to be used for displaying musical scores, from a personal computer or the like via a communication network, then load a desired music piece data set or musical score data set from the accessed site into the personal computer or the like, and then listen to a desired music piece or view a desired musical score using an electronic musical instrument etc. possessed by the user. A multiplicity of items of content, such as music piece data sets and musical score data sets, are stored sequentially in the music data selling site, and so any interested user has to search for desired content from among the multiplicity of stored content. One known approach for the user to search for desired content is to cause a search to be performed using, for example, the names of a music piece, artist, etc. as keywords and cause the search results to be displayed on a Web page as content displaying information, necessary for the user to designate desired content, so that the user can designate the desired content from among the displayed content displaying information. Thus, the user can ultimately manage to arrive at the desired content by sequentially narrowing down the search on the basis of a plurality of keywords or the like. Heretofore, there have been known techniques in accordance with which: phone numbers and models of portable telephones (e.g., cellular phones) are prestored in a server in association with each other; once access is made to the server from any one of the portable phones, the model of the portable phone is identified from the phone number; and a music piece list of incoming call signaling (ringing) melody data sets fitting the model is displayed on the portable phone (e.g., Japanese Patent Application Laid-open Publication No. 2002-55685).

However, in the case where the user searches for and acquires a desired item of content, such as a music piece data set or musical score data set, from among the multiplicity of items of content accumulated in the predetermined music piece data selling site, the user has to ascertain or check whether the desired content is of a data type usable in his or her (possessed) electronic musical instrument, personal computer or the like. Namely, because, as regards the music piece data sets, musical score data sets, etc. the usable data type may differ among various models of electronic musical instruments or various types of tone generators (including software tone generators) that are provided in personal computers, it is possible that the content acquired from the predetermined music piece data selling site can not be used in the user-possessed electronic musical instrument or the like because of the data type of the acquired content and thus the acquired content becomes a waste. But, an ordinary user, particularly a beginner, often does not know what data type can be used in his or her electronic musical instrument, and it is very difficult for the user to correctly select, from among a plurality of items of the content displaying information displayed as a result of a keyword-based search, content of the data type that can be used in his or her electronic musical instrument. Even where the user knows what data type can be used in his or her electronic musical instrument, it would take a long time to select, from among the plurality of items of the content displaying information, content of the data type usable in his or her electronic musical instrument, so that fees to be paid by the user for connection to the communication network tend to increase considerably.

### SUMMARY OF THE INVENTION

In view of the foregoing, it is an object of the present invention to provide a content-delivering information supplying method, apparatus and program which supply content displaying information indicative of content usable in data reproducing equipment, such as an electronic musical instrument, possessed by a user so that desired content usable in the user's data reproducing equipment can be acquired efficiently by the user with no waste.

In order to accomplish the above-mentioned object, the present invention provides an information supplying method which comprises: a registration step of causing a user to select, from among a plurality of pieces of data reproducing equipment, particular data reproducing equipment to be used by the user, and registering the particular data reproducing equipment, selected by the user, in association with the user; a step of searching a plurality of items of content for particular content reproducible with the registered data reproducing equipment; and a step of supplying the user with content displaying information indicative of the searched-out particular content.

With the present invention thus arranged, it is possible for any interested use to readily search for content reproducible with particular data reproducing equipment to be used, e.g. a music piece data set of a data type capable of being performed by an electronic musical instrument possessed by the user. The particular data reproducing equipment to be used by the user, selected from among a plurality of pieces of data reproducing equipment, is registered. For example, when the user has accessed a predetermined site, a search is performed through a plurality of items of content only for particular content reproducible with the registered data reproducing equipment of the user, and content displaying information indicative of the searched-out particular content is supplied to the user. Thus, by just having the particular data reproducing equipment to be used registered in advance, the user is supplied with only content displaying information indicative of content necessary for the user and can then acquire content from the predetermined site in accordance with the content displaying information, without going to the trouble of checking a data type reproducible with the data reproducing equipment to be used. In this manner, only the content displaying information indicative of content reproducible with the user-possessed data reproducing equipment to be used by the user is supplied or presented to the user, and thus the user can acquire desired content efficiently with no waste.

The present invention may be constructed and implemented not only as the method invention as discussed above but also as an apparatus invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

While the embodiments to be described herein represent the preferred form of the present invention, it is to be understood that various modifications will occur to those skilled in the art without departing from the spirit of the invention. The scope of the present invention is therefore to be determined solely by the appended claims.

### BRIEF DESCRIPTION OF THE DRAWINGS

For better understanding of the object and other features of the present invention, its embodiments will be described in greater detail hereinbelow with reference to the accompanying drawings, in which:

FIG. 1 is a system block diagram showing an exemplary general setup of a content-delivering information supply system in accordance with an embodiment of the present invention;

FIG. 2 is a block diagram showing an exemplary hardware setup of one of various apparatus employed in the information supply system of FIG. 1;

FIG. 3 is a flow chart showing an embodiment of a content-delivering information supply processing carried out in the system;

FIG. 4 is a conceptual diagram showing an example of a user-possessed instrument registration screen;

FIG. 5 is a conceptual diagram showing an example of a music-data selling site display screen;

FIG. 6 is a conceptual diagram showing an example of a user-possessed instrument setting change/cancellation screen; and

FIG. 7 is a conceptual diagram showing an example of a search result display screen.

### DETAILED DESCRIPTION OF THE INVENTION

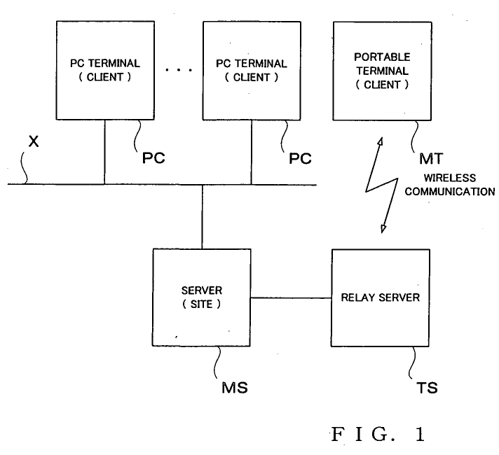

FIG. 1 is a system block diagram showing an exemplary general setup of a content-delivering information supply system in accordance with an embodiment of the present invention. The content-delivering information supply system of FIG. 1 comprises: at least one server MS that performs creation/delivery of Web pages and content delivery, user's portable terminals (hereinafter also referred to as clients), such as personal computer terminals PC, PDAs and portable phones (e.g., cellular phones), that give various instructions to the server MS; and a communication network X interconnecting the server MS and clients. As will be later described in detail, each of the above-mentioned various apparatus (i.e., the server MS and clients), constituting the information supply system of the present invention, comprises an independent computer including a processing unit composed of a CPU, ROM, RAM, etc., a storage unit, a communication unit, etc. Each of the apparatus can communicate (i.e., transmit and receive) content, content displaying information, etc. via the communication network X, such as the Internet or dedicated line, or wireless communication. Although the information supply system of the invention may employ other hardware components than the above-mentioned, it will be described hereinafter in relation to a case where only minimum necessary resources are employed in the system.

In the instant embodiment, the terms “content” are used herein to refer to a set of data, such as a music piece data set or musical score data set, deliverable via the communication network X, and the terms “content displaying information” are used herein to refer to displaying information composed of unique texts and images corresponding to items of content and introducing the items of content for reference purposes.

In the information supply system of FIG. 1, an interested client user uses a predetermined software program, such as a well-known network browser, to select, from among a plurality of sites stored in the server MS, a desired music data selling site (hereinafter also referred to as a “music site”) that sells user-desired content, such as a music piece data set or musical score data set. Then, content displaying information indicating, for reference purposes, items of content, such as music piece data sets and/or musical score data sets, is obtained by the server MS, storing the selected music site, as a result of a search through a music information database in accordance with a registered type of a particular musical instrument possessed by the user. The thus-obtained content displaying information is supplied to the client, so that the user is allowed to purchase or test-listen to desired content with reference to the supplied content displaying information. The information supply system of FIG. 1 is a network system that implements the aforementioned operations using the existing communication network X.

Each of the clients, constituting part of the information supply system of FIG. 1, can access any desired one of the plurality of sites stored in the server MS in accordance with a user's access request (e.g., designation of a URL (Uniform Resource Locator). For example, each of the sites stored in the server MS on the communication network X is managed as an HTML (Hyper Text Markup Language) file that is displaying information forming a basis for creation of a plurality of Web pages described by the HTML representation. Each of the HTML files is imparted with a URL indicative of a unique address on the communication network X. For example, the URL is address information to be used to designate an HTML file stored in a given server MS and is made up of character string information. The client can read out a user-desired HTML file from the server MS by designating the unique URL of the desired HTML file and display the site on the basis of the read-out HTML file. The way of displaying the site on the basis of the HTML file is well known and hence will not be described here. As the user accesses a desired music site from among a multiplicity of sites in the server MS, the client receives an HTML file, including content displaying information, transmitted from the server MS having the accessed music site stored therein, and the music site is displayed on the client on the basis of the received HTML file. Then, the user of the client can designate content to be purchased or test-listened to, and the desired content is delivered (downloaded) from the server MS to the client in response to the user's content designation.

The server MS, constituting the information supply system of FIG. 1 along with the above-described clients, is a server computer that has prestored in a database (DB) a multiplicity of HTML files (or HTML file creation programs) to be used for display, in any of the clients, of selected sites, content and user information, and that performs operations for transmitting various information, read out from the database on the basis of a request from any of the clients connected to the server MS via the communication network X, to the client. Namely, the server MS provides information delivery service. For example, in response to a client's request for access (e.g., designation of an URL) to a predetermined music site, the server MS transmits, to the client, an HTML file related to the predetermined music site. Specifically, at that time, the server transmits, to the client, an HTML file including content displaying information that is indicative of content obtained by searching through the music information database in accordance with registration information of a musical instrument possessed by the user of the client, and the server transmits, to the client, content corresponding to a content purchase request or test-listen request given from the client.

Each of the portable phones, PDAs etc. used as the clients is a small-sized portable terminal capable of wireless communication and has, in addition to the primary communication function, a site display function and content reproduction function for reproducing content delivered from the server MS. Namely, like personal computer terminals etc., each of the portable terminals is provided with a predetermined display device capable of displaying a user-desired site and various circuits, systems, etc. for receiving and storing/reproducing content transmitted by the server MS However, when bidirectional communication is to be performed by connecting such a portable terminal to the server apparatus MS, a relay station TS has to intervene. The relay server TS relays transmission/reception of various signals between the portable terminal MT and the server MS so that the portable terminal MT can access the server MS through the intervention of the relay server TS.

Note that the clients may be in the form of other equipment than the above-described personal computer terminals PC and portable terminals MT, as long as they can acquire an HTML file and content from the server MS and process the acquired HTML file and content. For example, the clients may be fixed land phones, game equipment, set-top boxes, electronic musical instruments, etc. Further, in the embodiment of FIG. 1 a plurality of the clients and a plurality of the servers MS may of course be connected to the communication network X. Further, whereas the embodiment of FIG. 1 has been described above in relation to the case where a desired site is displayed on the basis of an HTML file, it may be designed to display a desired site on the basis of another similar file (e.g., one using page description language or the like).

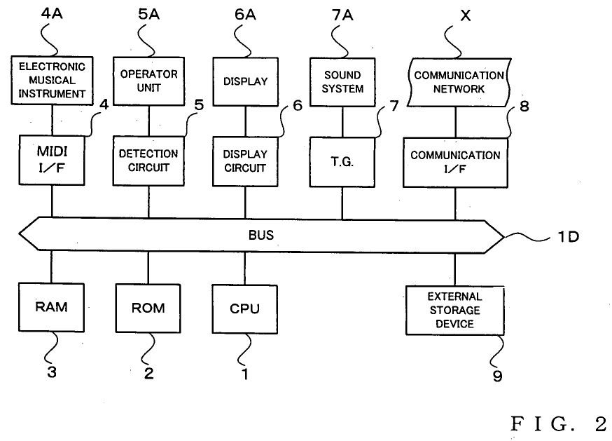

The personal computer terminal PC, portable terminal MT, server MS and relay server TS are similar in general hardware setup to one another, and thus the hardware setup of just one of the personal computer terminal PC, portable terminal MT, server MS and relay server TS will hereinafter be outlined representatively with reference to FIG. 2. FIG. 2 is a block diagram showing an exemplary hardware setup of one of the above-mentioned apparatus, which is, in the illustrated example, the personal computer terminal PC.

The personal computer terminal PC in the embodiment of the information supply system is controlled by a microcomputer comprising a microprocessor unit (CPU) 1, a read-only memory (ROM) 2 and a random-access memory (RAM) 3. The CPU 1 controls all operations of the entire personal computer terminal PC. To the CPU 1 are connected, via a bus 1D, the ROM 2, RAM 3, MIDI interface (I/F) 4, operation detection circuit 5, display circuit 6, tone generator circuit 7, communication interface (I/F) 8 and external storage device 9.

The ROM 2 has prestored therein various programs to be executed by the CPU 1 and various data to be referred to by the CPU 1. The RAM 3 is used for temporarily storing content, such as an HTML file, music piece data or musical score data, received from the server MS. The RAM 3 is also used as a working memory for storing various data generated as the CPU 1 executes the programs, as a memory for storing the currently-executed program and data related thereto, etc. Predetermined address regions of the RAM 3 are allocated to various functions and used as registers, flags, tables, memories, etc.

The MIDI interface (I/F) 4 is provided for inputting MIDI music piece data (MIDI data) from an external electronic musical instrument 4A, possessed by the user, to the personal computer terminal PC, and for outputting MIDI music piece data (MIDI data), downloaded from the server MS, to the electronic musical instrument 4A or the like. Note that the electronic musical instrument 4A may be of any type (or operating type), such as the keyboard type, guitar type, wind instrument type, percussion instrument type or gesture type, as long as it can generate MIDI data in response to manipulations by the user of the personal computer terminal PC. Note that the MIDI interface 4 may be a general-purpose interface rather than a dedicated MIDI interface, such as RS232-C, USB (Universal Serial Bus) or IEEE1394, in which case other data than MIDI event data may also be communicated at the same time as the MIDI event data. In the case where such a general-purpose interface as noted above is used as the MIDI interface 4, the electronic musical instrument 4A is designed to communicate other data than MIDI event data. Of course, the music piece data handled in the instant embodiment may be of any other data format than the MIDI format, in which case the MIDI interface 4 and electronic musical instrument 4A are constructed in conformity to the data format used.

Operator unit 5A may preferably comprise a combination of a mouse (point-and-click device), keyboard and special switch unit connected to or provided on the body of the personal computer terminal PC; note, however, that the operator unit 5A may be of any other suitable type. For example, the operator unit 5A may be in the form of a combination of a ten-button keypad for manual entry of numeric value data and keyboard for manual entry of character data, or panel switches. The operation detection circuit 5 constantly detects respective operational states of the individual operators on the operator unit 5A and outputs switch information, corresponding to the detected operational states of the operators, to the CPU 1 via the bus (e.g., data and address bus) 1D. The display circuit 6 visually displays, on a display device 6A such as a liquid crystal display (LCD) panel or CRT (Cathode Ray Tube), not only a music site screen and musical score screen on the basis of an HTML file and musical score data received from the server MS, but also controlling states of the CPU 1, etc.

The tone generator (T.G.) circuit 7, which is capable of simultaneously generating a plurality of tone signals in a plurality of channels, receives music piece data supplied via the bus 1D, and generates tone signals on the basis of the received music piece data. Each of the tone signals thus generated by the tone generator circuit 7 is audibly reproduced or sounded by a sound system 7A including amplifiers and speakers. The provision of the tone generator circuit 7 allows the personal computer terminal PC to function as performance equipment (i.e., music piece data reproducing equipment). The music piece data may be either in a digitally-encoded format such as the MIDI format or in a waveform sample data format such as the PCM, DPCM or ADPCM. The tone generator circuit 7 and sound system 7A may be constructed in any desired conventional manner.

Further, the communication interface (I/F) 8 is connected to the communication network X, such as a LAN, Internet or telephone line network, via which it can be connected to a desired server MS or the like. Thus, with the communication interface 8, the personal computer terminal PC can receive, from the server MS, content, such as an HTML file, music piece data or musical score data, via the communication network X. For example, if a particular HTML file or music piece data to be reproduced for tone generation is not stored in the ROM 2 or external storage device (e.g., hard disk) 9 of the personal computer terminal PC, the communication network 8 is used for downloading the particular HTML file or music piece data from the server MS. It should be appreciated that the communication interface 8 and communication network X may be of either or both of wired and wireless types. The external storage device 9 is provided for storing content, such as HTML files, music piece data, musical score data and various programs to be executed by the CPU 1, received from the server MS. Where a particular control program is not prestored in the ROM 2, the particular control program may be prestored in the external storage device (e.g., hard disk device) 9, so that, by reading the particular control program from the external storage device 9 into the RAM 3, the CPU 1 is allowed to operate in exactly the same way as in the case where the particular control program is stored in the ROM 2. This arrangement greatly facilitates version upgrade of the control program, addition of a new control program, etc. The external storage device 9 may use any one or combination of various removable-type storage media other than the hard disk (HD), such as a flexible disk (FD), compact disk (CD-ROM, CD-RAM or CD-RW), magneto-optical disk (MO) and digital versatile disk (DVD).

Note that the server MS and relay server TS need not necessarily include the above-described electronic musical instrument 4A, tone generator circuit 7 and sound system 7A. In the portable terminals MT, the operator unit 5A and display device 6A are various switches and LCD etc. provided on (or built in) the body of the terminal MT, and the tone generator circuit 7 and sound system 7A are preferably provided on (or built in) the body of the terminal MT. The communication interface 8 in the portable terminals MT is a wireless communication device capable of communicating with the relay server TS, although it may of course a wired communication device as in the personal computer terminals PC. The external storage device 9 may be either one previously built in the body of the portable terminals MT, or one externally connectable to the body of the portable terminals MT via a cable or otherwise. In the case where the external storage device 9 is previously built in the body of the portable terminals MT, it is preferable to use a small-size drive for driving a small-size semiconductor memory of a stick or card shape.

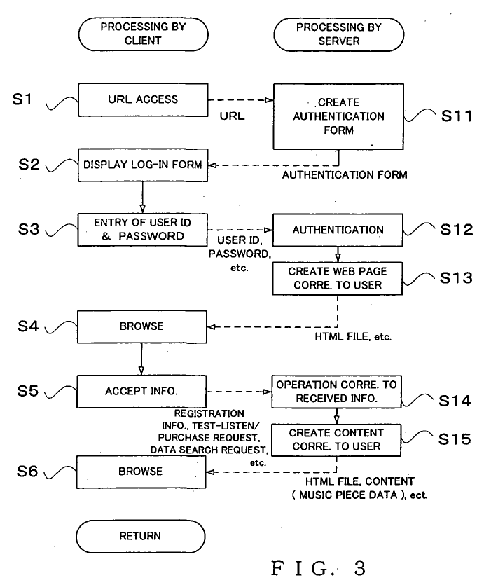

As set forth above, the information supply system of FIG. 1 is constructed to supply each interested user with content displaying information, indicative of content usable in a particular musical instrument possessed by the user (i.e., user's musical instrument), so that, using the supplied content displaying information, the user is allowed to readily acquire, from the server MS, desired content usable in the user's musical instrument. The following paragraphs describe “content-delivering information supply processing” directed to such purposes. FIG. 3 is a flow chart showing an embodiment of the content-delivering information supply processing, where the information supply processing is shown as a series of operations carried out between the client, such as the personal computer terminal PC or portable terminal MT, and the server MS.

First, at step S1, the client makes URL access to the server MS storing a music site desired by the user. Namely, if access is to be made from the client, via the communication interface 8 and communication network X, to a desired music site of the server, a URL indicative of the desired music site is transmitted from the client to the server MS. Upon receipt of the URL from the client, the server MS creates an authentication request form described in HTML representation and returns the thus-created authentication request form to the client, at step S11. The client displays a log-in form on the basis of the authentication request form returned from the server MS at step S2, and accepts user's entry of a user ID and password at step S3. Once the user ID and password are duly entered, the server authenticates the user on the basis of the entered user ID and password, at step S12. The authentication is performed by ascertaining whether the entered user ID and password match registered information in a client information database provided in and managed by the server MS.

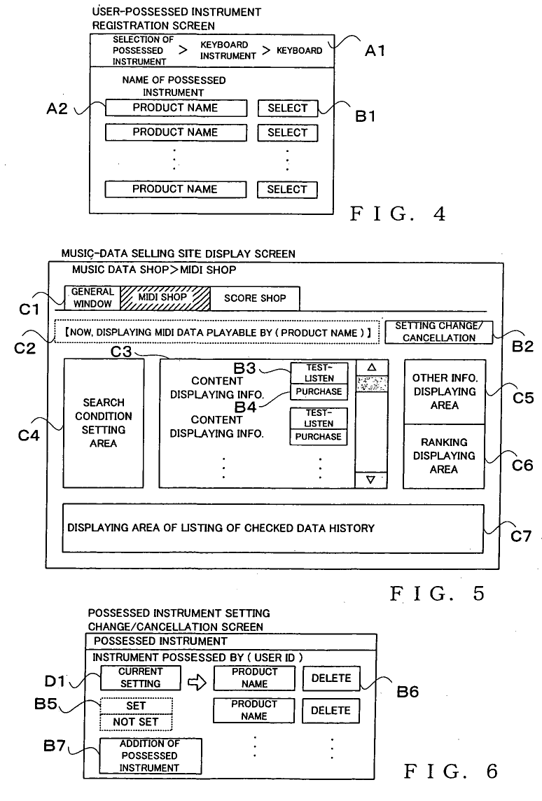

If the authentication of the user has been performed appropriately at step S12, the server MS creates a Web page corresponding to the user with reference to the client information database, music information database etc. provided in and managed by the server MS, and transmits the created Web page to the client as an HTML file (step S13). The client information database is a database storing user IDs and passwords of individual users and other user information, such as e-mail addresses, names and addresses of the individual users and registered instrument IDs assigned to musical instruments registered as possessed by the users. The music information database is a database storing a multiplicity of items of content, such as music piece data sets and musical score data sets, respectively imparted with instrument IDs. If the user in question is one for which no registered instrument ID is stored in the client information database, the server MS creates a Web page showing a “user-possessed instrument registration screen” of FIG. 4 to be later described, while, if the user in question is one for which a registered instrument ID is stored in the client information database, then the server MS creates a Web page showing a “music-data selling site display screen” of FIG. 5 to be later described. In the latter case, the server MS searches the music information database for music piece data sets and musical score data sets imparted with the same instrument ID as the registered instrument ID of the user, and the searched-out music piece data sets and musical score data sets are set as contents of content displaying information and creates a Web page showing a “music-data selling site display screen” with the thus-set content displaying information presented thereon.

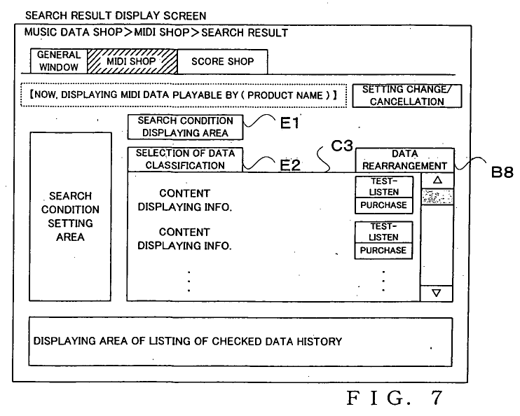

Once the client receives the HTML file for displaying the Web page created by the server MS, it carries out an operation for displaying a screen based on the received HTML file, at step S4. Namely, the client displays the “user-possessed instrument registration screen” or “music-data selling site display screen” on the display device 6A. At next step S5, the client accepts information input or entered by the user and transmits the user-input information to the server MS. Example of the user-input information is registration information of the user-possessed musical instrument entered via the “user-possessed instrument registration screen”, a test-listen/purchase request, setting change/cancellation request of the user-possessed musical instrument entered via the “music-data selling site display screen”, or data search request. Upon receipt of the user-input information from the client, the server MS carries out an operation corresponding to the received information, at step S14. Then, at step S15, the server MS creates a new Web page corresponding to the received user-input information and transmits an HTML file to the client, or transmits the corresponding music piece data and musical score data. For example, if the registration information of the user-possessed musical instrument entered via the “user-possessed instrument registration screen” has been received from the client, the server MS stores the registered instrument ID of the user's musical instrument in the client information database on the basis of the registration information, and transmits an HTML file for displaying the “music-data selling site display screen” as a screen to be next displayed. If, on the other hand, the test-listen/purchase request entered via the “music-data selling site display screen” has received from the client, the server MS reads out the corresponding music piece data or musical score data from the music information database. In the case of the test-listen request, part of the read-out music piece data or musical score data is transmitted to the client, but, in the case of the purchase request, all of the read-out music piece data or musical score data are transmitted to the client. Further, if the setting change/cancellation request of the user-possessed musical instrument has been received, the server MS transmits an HTML file for displaying a later-described “user-possessed instrument setting change/cancellation screen” (FIG. 6) as a screen to be next displayed. Furthermore, if the data search request has been received, the server MS transmits an HTML file for displaying a later-described “search result display screen” (FIG. 7) as a screen to be next displayed. In turn, the client carries out an operation for displaying the corresponding screen on the basis of the HTML file received from the server MS, reproducing a music piece on the basis of the music piece data and by use of the electronic musical instrument 4A, or displaying a musical score on the basis of the musical score data (step S6).

Here, a description will be made about each of the screens displayed on the client on the basis of the HTML file received from the server MS. FIG. 4 is a conceptual diagram showing an example of the “user-possessed instrument registration screen”. The “user-possessed instrument registration screen” is displayed in response to log-in operation by a user for which no registered instrument ID is stored in the client information database, or when a user-possessed instrument adding button B5 has been selected on the “user-possessed instrument setting change/cancellation screen”. The “user-possessed instrument registration screen” is a screen to be used for the user to register a particular musical instrument possessed by the user.

As illustrated in FIG. 4, the “user-possessed instrument registration screen” includes at least a category displaying area A1 and a user-possessed instrument registering area A2. The category displaying area A1 is an area for designating a particular category of a musical instrument which the user wishes to have registered as his or her possessed musical instrument; in the illustrated example, a keyboard section of a keyboard musical instrument is designated. Examples of the musical instrument categories include major categories, such as “keyboard musical instrument”, “DTM (Desk Top Music) tone generator” and “software tone generator”, minor categories, such as “electronic organ”, “piano”, “synthesizer” and “portable keyboard” in the “keyboard musical instrument” category, etc. Each of various musical instruments is classified to belong to any of the categories. By the user sequentially selecting the major and minor categories, a listing of all musical instruments belonging to the selected minor category can be displayed in the user-possessed instrument registering area A2. Specifically, a listing of product names and model names of all the musical instruments belonging to the selected minor category is displayed in the user-possessed instrument registering area A2. Further, selecting buttons B1 are displayed in corresponding relation to the musical instruments belonging to the selected minor category, so that the user can operate one of the selecting buttons B1, corresponding to the user-possessed musical instrument, to have the user-possessed musical instrument registered. Namely, by the user operating one of the selecting buttons B1, a registered instrument ID is added to information of the user currently stored in the client information database of the server MS.

FIG. 5 is a conceptual diagram showing an example of the “music-data selling site display screen”. The “user-possessed instrument registration screen” is displayed in response to log-in operation by a user for which a registered instrument ID is already stored in the client information database (see step S3), or when registration information of a user-possessed musical instrument entered via the “user-possessed instrument registration screen” has been received from a client. The “music-data selling site display screen” is a screen to be used for supplying the user with content displaying information indicative of content that is usable in the user-possessed musical instrument and has been searched out on the basis of the information of the user-possessed musical instrument.

As illustrated in FIG. 5, the “music-data selling site display screen” includes a to-be-displayed-data selecting area C1 that is an area for selecting a type of data for which content displaying information is to be displayed. In the illustrated example of the to-be-displayed-data selecting area C1, there are shown a “general window” tag for causing newly-arrived music piece data and musical score data to be displayed, a “MIDI shop” tag for causing only MIDI data to be displayed and a “musical score” tag for causing only musical score data to be displayed. The “music-data selling site display screen” also includes a user-possessed instrument displaying area C2 for displaying a musical instrument currently set as a “subject of change/cancellation” via the “user-possessed instrument setting change/cancellation screen” (FIG. 6) from among one or more registered musical instruments of the user. “setting changing/canceling” button B2 is a button for calling the “user-possessed instrument setting change/cancellation screen”. Content information displaying area C3 is an area for displaying only content displaying information indicative of only content usable in the musical instrument displayed in the user-possessed instrument displaying area C2. Namely, the content displaying information displayed in the content information displaying area C3 concerns only data that belong to the data type selected via the to-be-displayed-data selecting area C1 and are usable in the musical instrument displayed in the user-possessed instrument displaying area C2. In the case of a music piece data set, specific examples of the content displaying information include information indicative of names of the music piece and artist, musical genre of the music piece, and comments introducing other music pieces. The content information displaying area C3 is also arranged to sequentially display content displaying information of all searched-out music piece data sets in response to user's operation of a scroll bar (depicted in FIG. 5 as a combination of a rectangular block and oppositely-directed black triangles) located at the right side of the displaying area C3. Test-listening and purchasing buttons B3 and B4, provided in corresponding relation to the individual content displaying information, are each a button for designating desired content to be test-listened to or purchased. Part or whole of the desired content is downloaded from the server MS to the client.

The “music-data selling site display screen” also includes a search condition setting area C4 is an area for entering one or more additional search conditions to further search for content from the content displaying information displayed in the content information displaying area C3 with the narrowed conditions. For example, if the user operates a search start button (not shown) after entering one or more additional search conditions, such as names of the music piece and artist and musical genre of the music piece, theme (e.g., relaxing music piece, music piece for a party, or music pieces separated by age), keyword, and/or tie-up music piece or commercial music piece, a listing of content displaying information of music piece data sets, having been searched out in accordance with the one or more additional search conditions, is displayed in the content information displaying area C3. Other information displaying area C5 is an area for displaying other information to be supplied to the user than the content displaying information, such as information explanatory of the current music-data selling site display screen and data type. Ranking information displaying area C6 is an area for displaying a ranking of music piece data sets having been test-listened to or purchased so far by various users. Different contents are displayed in the ranking information displaying area C6 depending on the musical instrument currently set as the subject of change/cancellation via the “user-possessed instrument setting change/cancellation screen” (see FIG. 6). The music-data selling site display screen further includes a checked-data history listing displaying area C7 is an area for displaying music piece data sets having been checked so far by the user in question, e.g. information preserved as a checked product history when the user has performed operation for viewing further details of data selected from among the content displaying information or for test-listening to a music piece selected from among the content displaying information. Although not specifically shown, test-listen/purchase buttons etc. may be displayed in the checked-data history listing displaying area C7 too so that the user can test-listen to or purchase a desired music piece directly via this displaying area C7.

FIG. 6 is a conceptual diagram showing an example of the “user-possessed instrument setting change/cancellation screen”. The “user-possessed instrument setting change/cancellation screen” is displayed in response to user operation of the setting changing/canceling button B2 on the music-data selling site display screen (see step S5). This screen is provided for setting or changing a particular registered user-possessed musical instrument, for which content is to be searched for, from among one or more registered user-possessed musical instruments.

As illustrated in FIG. 6, a listing of one or more user-possessed musical instruments (in this instance, product names) currently registered by the user via the “user-possessed instrument registration screen” (see FIG. 4) or the like is displayed on the “user-possessed instrument setting change/cancellation screen”. For a given musical instrument currently set as a subject of change/cancellation (i.e., set in a search mode) from among the registered user-possessed musical instruments thus displayed, a “currently set in search mode” sign D1 is additionally displayed. Only for the user-possessed musical instrument currently set in the search mode (i.e., currently selected user-possessed musical instrument), content displaying information is presented to the user on the music-data selling site display screen (see step S5). The “user-possessed instrument setting change/cancellation screen” also includes a “Set” button B5 for setting a particular user-possessed musical instrument, selected from among the displayed user-possessed musical instruments, in the search mode, and a “Not Set” button B5 for canceling the search mode (i.e., selected state) of a particular one of the displayed user-possessed musical instruments. Deleting buttons B6, which are provided in corresponding relation to the registered user-possessed musical instruments, are each operable to delete the corresponding registered user-possessed musical instrument from the client information database; that is, each of the deleting buttons B6 is provided for canceling registration of the corresponding user-possessed musical instrument. Further, a user-possessed musical instrument adding button B7 is operable to call the “user-possessed instrument registration screen” in order to have a new user-possessed instrument additionally registered.

Here, let it be assumed that only one user-possessed musical instrument can be currently set in the search mode, i.e. only one musical instrument product name can be imparted with the “currently set in search mode” sign D1. The musical instrument product name thus imparted with the “currently set in search mode” sign D1 (i.e., musical instrument product name currently set in the search mode) is displayed in the area C2 of FIG. 5, and the musical instrument product name displayed in the area C2 is set in the search mode). In this manner, a search is performed for the musical instrument product name displayed in the area C2, in order to detect, from among a plurality of items of content, all content reproducible by a musical instrument of the product name displayed in the area C2. Then, content displaying information pertaining to the detected content is displayed in the area C3 of FIG. 3.

Needless to say, two or more user-possessed musical instruments may be currently set in the search mode, i.e. two or more musical instrument product names can be imparted with the “currently set in search mode” sign D1. In such a case, two or more musical instrument product names currently set in the search mode) are displayed in the area C2 of FIG. 5, and all content displaying information indicative of content reproducible by musical instruments of the individual product names is displayed in the area C3. Therefore, in this case, the area C3 of FIG. 5 is preferably arranged to display the content displaying information indicative of the reproducible content separately for each of the musical instrument product names.

In the above-described example, a particular musical instrument product name to be currently in the search mode is selected, by the user operation via the screen of FIG. 6, from among one or more user-possessed musical instruments already registered for the user, and the thus-selected musical instrument product name is displayed in the area C2 of FIG. 5. Alternatively, however, a particular musical instrument product name to be currently in the search mode may be automatically selected from among one or more user-possessed musical instruments already registered for the user. For example, user-possessed musical instruments may be sequentially selected, one by one, with the passage of time from among the one or more user-possessed musical instruments already registered for the user, and a search may be performed with each of the thus automatically-selected user-possessed musical instrument names displayed in the area C2 of FIG. 5 so that searched-for content displaying information is displayed in the area C2 of FIG. 5.

FIG. 7 is a conceptual diagram showing an example of the “search result display screen”. The “search result display screen” is displayed when a search has been performed in accordance with one or more additional search conditions entered into the search condition setting area C4 of the “music-data selling site display screen” of FIG. 5. Namely, the “search result display screen” is a screen for presenting content displaying information indicative of content further searched out, from among the content searched out on the basis of the user-possessed musical instrument, in accordance with one or more additional search conditions additionally entered by the user, such as a keyword.

As seen in FIG. 7, the “search result display screen” is substantially similar in arrangement and function to the “music-data selling site display screen” except for part of the screen; thus, only portions of the “search result display screen” different from the “music-data selling site display screen” will be explained here. Search condition displaying area E1 is provided for displaying one or more search conditions entered into the search condition setting area C4 of the “music-data selling site display screen” of FIG. 5. For example, when a music piece name has been designated as the search condition, the designated music piece name is displayed. Data classification selecting area E2 is provided for displaying a tag for causing searched-out content to be classified and displayed. Examples of such a tag include a “all music piece data” tag for displaying all of the searched-out music piece data sets, a “lessen-function-corresponding music piece data” tag for displaying only one or more music piece data sets corresponding to a lessen function, etc. Selecting any one of the tags can change content displaying information displayed in the content information displaying area C3. Namely, the tag performs a search function for narrowing down the content in accordance with the data classification. Further, a data rearranging button B8 is a button for rearranging items of the content displaying information displayed in the content information displaying area C3 in accordance with a predetermined condition, such as in ascending or descending order of data arrival or in Japanese or English alphabetical order.

As having been set forth above, the server MS in the instant embodiment has stored therein a multiplicity of music piece data sets and musical score data sets of various music pieces, with the music piece data set and musical score data set of each music piece being recorded in various different formats. Once a user having a registered musical instrument accesses a music site managed by the server MS, a search is performed for only one or more music piece data sets of a given format usable in the user's registered musical instrument, i.e. reproducible with an electronic musical instrument or the like possessed by the user, and one or more searched-out music piece data sets are listed on the “music-data selling site display screen”. If the user has designated, from among the listed music piece data sets, a particular music piece data set to be delivered from the server MS, only the music piece data set of the format reproducible with the user-possessed musical instrument is downloaded; thus, it is possible to eliminate waste downloading of music piece data non-reproducible with the user-possessed musical instrument. Further, because only one or more searched-out music piece data sets reproducible with the user-possessed musical instrument are listed, the user is advantageously allowed to efficiently find a desired music piece data set reproducible with the user-possessed musical instrument.

Whereas the above-described embodiment is arranged to perform user authentication using the client information database provided in and managed by the server, only one or more music piece data sets of a given format reproducible with a user-possessed electronic musical instrument or the like may be listed on the “music-data selling site display screen” with no user authentication performed. In such a case, however, because no user ID, registered instrument ID, etc. are stored in the client information database, it is not possible to list, on the “music-data selling site display screen”, only one or more music piece data sets of a given format reproducible with a user-possessed electronic musical instrument or the like unless the user-possessed musical instrument is registered each time the user access the site in question. Neither is it possible to list only one or more music piece data sets of a given format reproducible with a user-possessed musical instrument switched over from the previous one via the “user-possessed instrument setting change/cancellation screen”.

Note that, although various information, such as registration-related information of user-possessed musical instruments, has been described as being stored in the server, it may be stored in the client. In such a case, the various information may be retained in a so-called cookie.

In summary, the present invention arranged in the above-described manner can supply each interested user with only content displaying information indicative of content usable in data reproducing equipment possessed by the user, so that the user can efficiently acquire only content usable in the user's data reproducing equipment with no waste.

What is claimed is:

1. An information supplying method comprising:
a registration step of causing a user to select, from among a plurality of pieces of data reproducing equipment, particular data reproducing equipment to be used by the user, and registering the particular data reproducing equipment, selected by the user, in association with the user;
a step of searching a plurality of items of content for particular content reproducible with the data reproducing equipment registered by said registration step in association with the user; and
a step of supplying the user with content displaying information indicative of the particular content searched out by said step of searching.

2. A method as claimed in claim 1 wherein the content displaying information is information for making a content-introducing display for reference by the user in designating desired content deliverable via a communication network.

3. A method as claimed in claim 1 wherein said step of registering is capable of registering a plurality of pieces of data reproducing equipment for each user, and
said step of searching searches for content usable only in particular data reproducing equipment currently set in a search mode from among a plurality of pieces of data reproducing equipment registered in association with the user.

4. A method as claimed in claim 3 wherein said step of searching including a step of setting a desired one of the plurality of pieces of data reproducing equipment, registered in association with the user, in the search mode in response to a selection by the user.

5. A method as claimed in claim 4 wherein said step of setting includes a step of causing the user to select the desired one of the plurality of pieces of data reproducing equipment, registered in association with the user, via a display terminal of the user.

6. A method as claimed in claim 1 wherein said step of supplying presents, on a display terminal of the user, the content displaying information indicative of the searched out content.

7. A method as claimed in claim 1 which further comprises a step of allowing the user to make a selection for receiving a part or whole of content corresponding to the content displaying information supplied by said step of supplying.

8. A method as claimed in claim 1 wherein said step of searching is carried out in response to a request made by a particular user.

9. A method as claimed in claim 1 wherein a server apparatus for supplying information and a client terminal for receiving supplied information are interconnectable via a communication network, and said method is performed by using at least one of a computer of said server apparatus and a computer of said client terminal.

10. An information supplying apparatus comprising:
a registration section that causes a user to select, from among a plurality of pieces of data reproducing equipment, particular data reproducing equipment to be used, and registers the particular data reproducing equipment, selected by the user, in association with the user;
a section that searches a plurality of items of content for particular content reproducible with the data reproducing equipment registered in association with the user; and
a section that supplies the user with content displaying information indicative of the content searched out by said registration section.

11. An information supplying apparatus as claimed in claim 10 wherein a server apparatus for supplying information and a client terminal for receiving supplied information are interconnectable via a communication network, and said information supplying apparatus belongs to at least one of said server apparatus and said client terminal.

12. A program containing a group of instructions for causing a processor to perform information supply processing, said information supply processing comprising:
a registration step of causing a user to select, from among a plurality of pieces of data reproducing equipment, particular data reproducing equipment to be used by the user, and registering the particular data reproducing equipment, selected by the user, in association with the user;
a step of searching a plurality of items of content for particular content reproducible with the data reproducing equipment registered by said registration step in association with the user; and
a step of supplying the user with content displaying information indicative of the particular content searched out by said step of searching.

13. A program as claimed in claim 12 wherein a server apparatus for supplying information and a client terminal for receiving supplied information are interconnectable via a communication network, and said processor for performing said information supply processing is at least one of a computer of said server apparatus and a computer of said client terminal.
